(19) United States
(12) Patent Application Publication
(10) Pub. No.: US 2005/0102245 A1
(43) Pub. Date: May 12, 2005

(54) System, method, and service for negotiating schedules while preserving privacy through a shared representation

(75) Inventors: Stefan B. Edlund, San Jose, CA (US); Jared Jackson, Sammamish, WA (US); Vikas Krishna, San Jose, CA (US); Mark Molander, Cary, NC (US); Thomas Patrick Moran, Palo Alto, CA (US); Joann Ruvolo, San Jose, CA (US); Yael Shaham-Gafni, Haifa (IL)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/704,350

(22) Filed: Nov. 7, 2003

(51) Int. Cl. G06F 17/60

(52) U.S. Cl. 705/80

(57) ABSTRACT

A meeting negotiation system provides a new approach to scheduling events by negotiating schedules while preserving privacy through a shared representation that separates the meeting negotiation from the meeting invitation. The negotiation system integrates all scheduling-related information such as times users can meet, location, etc. and reduces dependency on designations of time as free or busy by a potential meeting attendee. Consequently, the negotiation system enables time preferences richer than just free or busy, allowing potential meeting attendees to designate preference in addition to time available. The negotiation system supports annotations and comments as a discussion mechanism, giving feedback to the meeting scheduler before the meeting invitation is issued. Possible times provided for the meeting are provided in the form of a bounded negotiation; participants may select the best time for them to attend a meeting from the bounded negotiation. The meeting organizer finalizes the meeting time from the responses provided by participants.

### FIELD OF THE INVENTION

The present invention generally relates to electronic calendaring. More specifically, the present invention relates to a method for negotiating the details of a meeting such as time without requiring participants to relinquish control of their calendars or information on their calendars to a meeting organizer.

### BACKGROUND OF THE INVENTION

Scheduling of meetings is typically fraught with problems; the process is cumbersome and disruptive for all involved. This is particularly the case when a meeting scheduler has no management or other control over those whose attendance is either desired or necessary. A typical approach to scheduling meetings is to issue an invitation to all persons the meeting scheduler wishes to attend for a specific time at a specific place for a specific agenda. Consequently, invitations present an image as being very formal in workflow structure and tone, discouraging needed discussion regarding the meeting, agenda, etc. Often, after an invitation has been issued, the meeting scheduler has to revise the invitation and reissue it, broadcasting trivial changes.

One conventional solution to the issues of scheduling meetings is to have each employee or person desired at a meeting post an electronic calendar that can be viewed on a network by other employees or persons. Persons who wish to schedule a meeting can then view the electronic calendars of those they wish to attend the meeting and set the meeting time to coincide with attendees' available time. However, electronic calendars are typically not an accurate reflection of a user's time for a variety of reasons. Many users do not maintain an electronic calendar. Most users do not record all activities, in particular everyday events (e.g., travel to or from work, lunch, jogging). Many users do not put sensitive information such as doctor's appointments in an electronic calendar that may affect their availability for a meeting.

Even if a calendar accurately reflected a user's time, many issues are associated with personal privacy and control over information and time when a person is busy or available for meetings (busy free vs. free time). Employees have differing levels of desired privacy regarding their own personal information. Whether information is private is relative to whose information it is. For example, one person may consider his medical appointments private, while others may consider it harmless.

Even when information is not private to an individual it may still be socially sensitive. For example, an internal job interview for an applicant might be information the applicant does not want his group members or supervisor to know. Information posted on an electronic calendar available to other employees might compromise company security. For example, a meeting topic or list of attendees on an electronic calendar might expose confidential information or reveal undisclosed business strategy to unauthorized personnel. In addition, dissemination of an employee's electronic calendar may present an unintended description of the employee's use of time, leading to peer judgment regarding time management and allocation. Further, some people do not wish to relinquish control of their schedule or themselves as reflected by their schedule.

Conventional methods to facilitate meeting scheduling comprise the broad categories of open calendar and calendar delegation (free-time access). An open calendar improves coordination as a meeting scheduler can see a colleague's time allocation and can also make inferences as to the quality or nature of time allocated on the colleague's calendar, allowing the meeting scheduler to select a meeting time that all invitees can attend.

However, there are numerous privacy and social issues with the open calendar approach. These issues can be managed through a variety of methods, for example, restricting what others see by access settings, creating cryptic and context-sensitive entries to mask the meaning of the entries, omitting private entries, and scheduling work time or fake appointments in calendars to limit the free time for potential scheduling.

A less open method that attempts to solve scheduling issues is to reduce a person's calendar to free or busy time. An employee, for example, designates a portion of the day as busy while the rest is free for scheduling meetings. While this approach eliminates the exposure of specific topics on an employee's calendar, it still delegates control of the calendar to others. While an employee may be free at a specific time, the employee may have preferences for the meeting time that are not conveyed by a simple free vs. busy designation. In addition, the designation of free or busy time on an employee's calendar may allow inferences by colleagues or supervisors regarding the employee's time management. Again, the employee is exposing information they would prefer kept private.

iCalendar™ is an object model that defines a common format for openly exchanging calendaring and scheduling information across the internet. iCalendar defines a free/busy time type, with the default being busy. This model defines possible categories for times on an employee's calendar as free, busy, busy-unavailable, or busy-tentative. Free time refers to a time interval free for scheduling by others. Busy refers to a time interval that already has one or more events scheduled. Busy-unavailable refers to a time interval that is busy and cannot be scheduled. Busy-tentative refers to a time interval that is busy because one or more events have been tentatively scheduled.

A calendar system based on free/busy time, though a useful model, is only as effective as it is accessible by participants or organizers and as accurate as the calendars of the individual participants. Since participants of calendaring systems often fail to keep their calendars current, many difficulties arise in implementing such a system.

Although this technology has proven to be useful, it would be desirable to present additional improvements. What is therefore needed is a system, a computer program product, and an associated method that would allow users to negotiate the details of a meeting without revealing personal information. Such an approach would allow meeting schedulers to negotiate the details of the meeting before issuing invitations, eliminating the broadcast of trivial changes to the meeting. The need for such a solution has heretofore remained unsatisfied.

### SUMMARY OF THE INVENTION

The present invention satisfies this need, and presents a system, a computer program product, a service, and an associated method (collectively referred to herein as “the system” or “the present system”) for a new approach to scheduling, negotiating schedules while preserving privacy through a shared representation. The present system integrates all scheduling-related information such as times users can meet, location, etc.

In addition, the present system reduces dependency on designations of time as free or busy by a potential meeting attendee. Consequently, the present system enables time preferences richer than just free or busy, allowing potential meeting attendees to designate preference in addition to time available. The present system supports annotations and comments as a discussion mechanism, giving feedback to the meeting scheduler before the meeting invitation is issued. Further, the present system supplements negotiation of meeting details that typically occurs via email, instant messaging, phone, etc.

The present system provides the features of offering possible meeting times to participants rather than specifying the meeting time in advance. In addition, possible times provided for the meeting are provided in the form of a bounded negotiation, e.g., participants may select the best time for them to attend a meeting from the bounded negotiation of Thursday or Friday, 2:00 pm to 5:00 P.M. Furthermore, the present system is a dynamic negotiation object that interacts with the meeting organizer and participants to identify the best time for the meeting.

In addition, the present system allows a multiplicity of negotiations on all aspects of a meeting in addition to time such as location, topic, agenda, etc. The present system may be used to negotiate any aspect of any event requiring attendance by participants that may benefit from advance input from participants or others. For example, the present system may be used to organize a ski weekend among friends, a fishing trip, a poker night, or a potluck where participants also designate food items to bring.

The present system separates the negotiation from the invitation. In addition, the present system decentralizes the negotiation, removing the burden of negotiation from the meeting organizer. Instead, the meeting organizer delegates the process to a negotiation object. Each participant interacts with the negotiation object until a mutually satisfactory time is determined. The negotiation process of the present system saves the meeting organizer from managing the details of the negotiation. In addition, the present system empowers the meeting participants to book the meeting organizer's time rather than the meeting organizer booking the participant's time, providing a more successful and less time-consuming approach to scheduling meetings.

A negotiation moderated by the present system involves two or more parties. In a typical case, the negotiation involves a meeting organizer and some number of participants. A meeting organizer initiates a negotiation with n participants; the participants provide their input to the negotiation. After viewing all the integrated scheduling information within the negotiation, the present system finalizes the negotiation. Finalizing the negotiation initiates an invitation for the event.

The process of negotiating a time in scheduling a typical meeting by the present system is summarized in the following steps. The organizer initiates a negotiation by specifying the known meeting attributes (e.g., subject of the meeting, location, duration, participants). The organizer also “offers” time interval(s) when he is willing to meet, associating with each interval his level of desirability (e.g., preferred, acceptable, unfavorable) in meeting at that time. For example, Monday afternoon is preferred and Friday 9-11 A.M. is acceptable. When offering his time intervals, the organizer may choose to view and take into account his or her own calendar and an aggregate view of the free time of all the participants, if available.

Upon being notified of a pending negotiation, a participant accesses the negotiation. In a process similar to the one followed by the negotiator, the participant offers the time interval(s) when he is willing to meet, associating with each interval his own level of desirability in meeting at that time. Depending upon a negotiation option, the participant may or may not be bound by the original time intervals offered by the organizer. If not bound, a participant is free to offer time intervals other than that originally proposed by the organizer. In either case, a participant indicates his preferences on the time intervals. When offering his or her time intervals, a participant may choose to view and take into account his or her own calendar and an aggregate view of those time intervals already offered by others and their desirability.

To determine the meeting time after all participants have responded to the negotiation, the organizer views the integrated scheduling information contained within the negotiation. This comprises an aggregate view of all the offered time intervals and their desirability. The organizer then selects the actual start time of the meeting, the duration having already been defined. Based on the information provided by the participants and the original meeting bounds, the organizer finalizes the negotiation. Finalizing the negotiation initiates an invitation for the event, which comprises the date/time of the meeting, the location, subject, participants, etc.

The present system presents the following advantages over conventional methods of organizing meetings. A negotiation of the present system supports a larger user base since it is not dependent on personnel or participants using an electronic calendar and keeping an accurate schedule on the calendar. In addition, the negotiation object of the present system preserves privacy. A user does not need to authorize others access to his calendar nor relinquish control to his information and time. A negotiation object contains only the information entered by the user for that event. Calendar delegation or free-time, busy-time access is not required. However, if free-time, busy-time access is available, the present system can use that information in the negotiation process.

Further, update communications amongst the organizer and participants are reduced since each party deals directly with the negotiation object. In addition, the negotiation object of the present system always reflects the latest state for the event being negotiated. The negotiation object may also reflect external actions that affect negotiation (e.g., time interval is no longer available). Furthermore, a negotiation provides a level of informality (e.g., offering time to meet) that is not typically associated with an official scheduled event, encouraging dialog between the organizer and participants and creating an atmosphere for more effective meetings. Also, negotiation within the negotiation object of the present system is not limited to time; for example, meeting participants, location, agenda, etc. may also be negotiated.

A feature of the present system is the time designation called offered time. Offered time is that time interval which is presented for acceptance or rejection, that is, those dates/times that the user has offered as being available. In the case of an accurate calendar, offered dates/times would most likely be the same or a subset of free time. In the case of an inaccurate calendar, offered dates/times would most likely be a superset of free time. However, offered time may be completely independent of free time. For example, although a user may have a meeting already scheduled, that time may still be offered as being available. A negotiation then occurs among the times offered by the organizer and the participant(s) to meet.

A proposed event may not have a predefined time; in this case, the present system presents bounded negotiation time intervals. For example, an organizer may propose a one-hour event with his colleagues any time this coming Wednesday or Friday afternoon. These offered times are bound by the bounded negotiation intervals. The organizer's colleagues may “negotiate” by offering their own bounded negotiation intervals. These intervals may limit the organizer's intervals (e.g., Wednesday from 2-4 PM) or may expand the organizer's intervals (e.g., all day Wednesday). Bounded negotiation intervals provide flexibility, allowing the parties of a proposed event to focus on the event and not the logistics. With its greater bounds, bounded negotiation time intervals also provide a better opportunity to find a mutually agreeable time.

A proposed event may not require specific participants. In some cases, having a representative from a group or someone with a specific role, etc. may satisfy the requirements of the event. For example, in a computer software company, an event to discuss the status of a product in development may desire a representative from the server team, the client team, and the security team. An organizer when proposing an event, can designate participants in many ways, including specifically naming a participant, naming a participant with an allowable replacement, designating that a participant from a named group should attend, and designating that a participant with a specific role (e.g., lawyer, accountant, VP) should attend.

A negotiation object integrates all scheduling related information. As an aggregate, the negotiation objects for past and current events provide a history from which patterns can be detected. These patterns of activity can be used to facilitate current or future negotiations by enabling automatic processing. Automatic processing can encompass, when appropriate, such things as preselecting the bounds of negotiation based on a user's scheduled events, preselecting the earliest start and end points (e.g., a user rarely meets before 8 AM or after 5 PM), preselecting participants based on the subject of the event, optimizing the finalization of an event, and accepting an event.

The negotiation object of the present system integrates all scheduling-related information such as times users can meet, location, etc. The present system always reflects the latest state of the event being negotiated. It may also reflect external actions that affect negotiation, for example, a time interval is no longer available.

The negotiation object comprises the time intervals offered by the organizer and participants. Some of the time intervals may be withdrawn from consideration, while others may be added. One reason for withdrawing an offered time might be that time is no longer available; for example, the offered time has been scheduled for some other event. A user may need to withdraw an offered time when a time interval is offered to many people as a potential meeting time. An offered time might also be withdrawn when a totally independent event is scheduled during this time. An offered time might be added if that time is now available, for example, a previous schedule event has been cancelled. A user has the option of whether new events scheduled within previously offered time should automatically be reflected in the negotiation object. A user can always manually update his offered time.

An advantage of a dynamic negotiation object is that when opened or viewed by a user, the dynamic negotiation object reflects the latest information at the time of access, eliminating the constant updates involved in typical scheduling and rescheduling operations.

The typical scenario for a negotiation is a “group event” where an organizer schedules a meeting with participants. Another common scenario involves peers collectively scheduling an event (e.g., a skiing weekend). In these cases, one negotiation object may be used to represent the negotiation of this one event. A less common scenario involves scheduling a series of individual meetings. For example, a manager would like to meet each member of his team individually once a week. Or an applicant is interviewing with each member of a team. In this case, one negotiation object can be used to represent the negotiation of many events, one for the “organizer” and each participant. For example, a manager may need to meet with five employees. Only one negotiation object is required to establish this series of meetings, not five. The subsequent negotiations span five events, one for each participant.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a meeting negotiation system of the present invention can be used;

FIG. 2 is a block diagram of the high-level architecture of the meeting negotiation system of FIG. 1;

FIG. 3 is a process flow chart illustrating an overview of a method of operation of the meeting negotiation system of FIGS. 1 and 2;

FIG. 4 is a diagram illustrating a user interface of the meeting negotiation system of FIGS. 1 and 2 for a meeting organizer initiating a meeting negotiation;

FIG. 5 is a diagram illustrating a user interface of the meeting negotiation system of FIGS. 1 and 2 for a participant responding to a meeting negotiation;

FIG. 6 is a diagram illustrating a user interface of the meeting negotiation system of FIGS. 1 and 2 for a meeting organizer finalizing a meeting negotiation;

FIG. 7 is a process flow chart illustrating a method of operation of the meeting negotiation system of FIGS. 1 and 2 for user login;

FIG. 8 is a process flow chart illustrating a method of operation of the meeting negotiation system of FIGS. 1 and 2 for initiating a negotiation; and

FIG. 9 is a process flow chart illustrating a method of operation of the meeting negotiation system of FIGS. 1 and 2 for responding to a negotiation.

### DETAILED DESCRIPTION OF PREFERRED EMBODIMENTS

The following definitions and explanations provide background information pertaining to the technical field of the present invention, and are intended to facilitate the understanding of the present invention without limiting its scope:

API (application program interface): A specific method prescribed by a computer operating system or by another application program by which a programmer writing an application program can make requests of the operating system or another application.

EJB (enterprise java bean): A Java API developed by Sun Microsystems that defines a component architecture for multi-tier client/server systems. Types of EJBs comprise session beans to perform processing, entity beans to represent data such as a row or a table in a database, and message driven beans to process Java Messaging Service (JMS) messages.

IIOP (Internet inter-orb protocol): A protocol based on Common Object Request Broker Architecture (CORBA) that defines how distributed objects communicate and allows client software on many platforms to access and use the same object on a server.

Internet: A collection of interconnected public and private computer networks that are linked together with routers by a set of standard protocols to form a global, distributed network.

Java: An object-oriented programming language developed by Sun Microsystems designed to generate applications that can run on all hardware platforms, small, medium and large, without modification.

JDBC (java database connectivity): A programming interface that lets Java applications access a database via the SQL language.

NP-completeness: A Polynomial-time reductions provide a formal means for showing that one problem is at least as hard as another, to within a polynomial-time factor. An NP problem is NP-complete if any other NP problem can be reduced to it in polynomial time.

SMTP (simple mail transfer protocol): A server-to-server protocol for delivering electronic mail that is the standard protocol used on the Internet; SMTP is also used on other TCP/IP networks.

SQL (structured query language): A language used to interrogate and process data in a relational database.

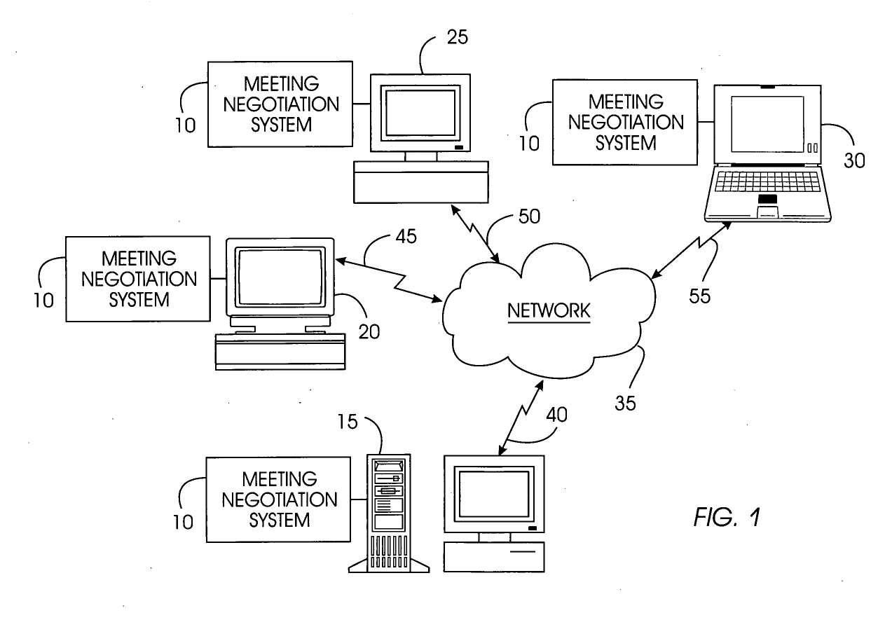

FIG. 1 portrays an exemplary overall environment in which a system and associated method for negotiating schedules while preserving privacy through a shared representation according to the present invention may be used. System 10 comprises a software programming code or a computer program product that is typically embedded within, or installed on a negotiation server 15. Alternatively, system 10 can be saved on a suitable storage medium such as a diskette, a CD, a hard drive, or like devices.

Users, such as remote Internet users, are represented by a variety of computers such as computers 20, 25, 30, and can access the negotiation server 15 through a network 35. Computers 20, 25, 30 each comprise software that allows the user to interface securely with the negotiation server 15. The negotiation server 15 is connected to network 35 via a communications link 40 such as a telephone, cable, or satellite link. Computers 20, 25, 30, can be connected to network 35 via communications links 40, 45, 50, 55, respectively. While system 10 is described in terms of network 35, computers 20, 25, 30 may also access system 10 locally rather than remotely. Computers 20, 25, 30 may access system 10 either manually, or automatically through the use of an application.

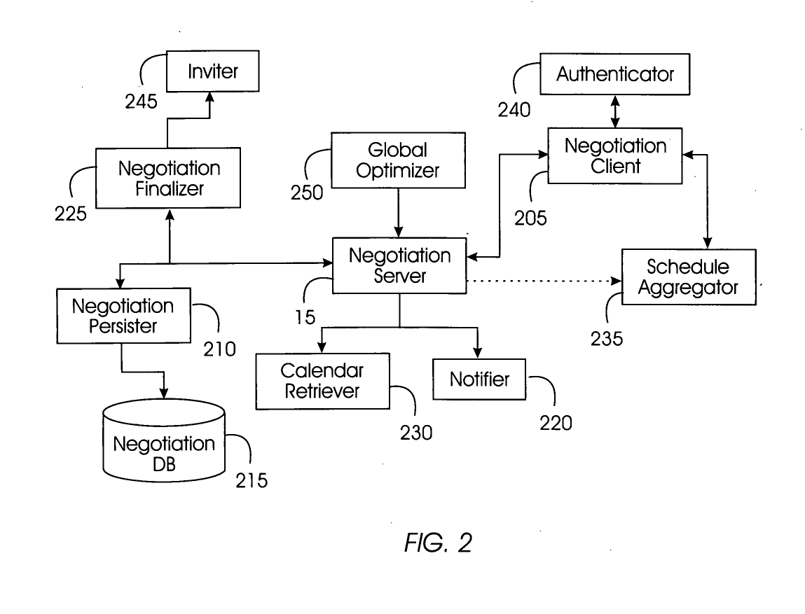

The high-level architecture of FIG. 2 comprises an overview of system 10. A meeting organizer creates a meeting negotiation, requesting participants to attend. The meeting organizer and participants are users of system 10 operating computers 20, 25, 30. The negotiation server 15 accepts requests from negotiation clients 205. Possible requests comprise: “Create new negotiation”, “Update an existing negotiation”, or “Finalize an existing negotiation”.

The negotiation server 15 interacts with a negotiation persister 210 to store, retrieve or update negotiations in a negotiation database 215. In addition, the negotiation server 15 interacts with a notifier 220 to issue notifications when new negotiations, have been created. Further, the negotiation server 15 interacts with a negotiation finalizer 225 to finalize negotiations. Furthermore, the negotiation server 15 uses a calendar retriever 230 to access free-time information from external calendaring systems.

The negotiation client 205 provides a user interface on the negotiation server 15 for creating, modifying or finalizing negotiations. The negotiation client 205 uses a schedule aggregator 235 to consolidate a negotiation object and its associated user feedbacks. The negotiation client 205 communicates with an authenticator 240 to retrieve the necessary credentials needed to access the negotiation server 15.

Given a negotiation that comprises feedback with preferences from participants, the schedule aggregator 235 consolidates the feedbacks into an aggregated representation for supporting the selection of an optimal timeslot for an event. The preferences comprise at least one preference indicator. The preference indicator, may be for example, and without limitation: an offered preference, a preferred preference, an acceptable preference, a problematic preference, a disfavored preference, an unacceptable preference, a thumb-based indicator (e.g., 2 thumbs up, 1 thumb up, no thumbs, 1 thumb down, and 2 thumbs down).

Many algorithms may be used to aggregate schedules, for example, a simple averaging of timeslots and their associated preference setting (preferred, acceptable, unfavorable or unacceptable) onto the time scale. In an embodiment of system 10, the negotiation server 15 calls the schedule aggregator 235 directly when a negotiation is updated and incorporates the optimized schedule into the negotiation object.

The negotiation persister 210 is responsible for persisting negotiations onto a persistent store, negotiation DB 215. The negotiation persister 210 creates, deletes, or updates negotiations on the negotiation DB 215.

The negotiation DB 215 contains the negotiations. Negotiation states may be finalized or not finalized. In an embodiment of system 10, the negotiation DB 215 is implemented as a relational database.

When a negotiation has been finalized, the negotiation finalizer 225 interacts with an inviter 245 so that invitations are sent out to all participants. The negotiation finalizer 225 also interacts with the negotiation persister 210 and marks the negotiation state as finalized in the database. Optionally, the negotiation finalizer 225 removes the finalized negotiation from the database; this function may also be performed during a later stage when the database is being compacted.

The negotiation server 15 uses notifier 220 to issue notifications to participants that a negotiation requiring their attention has been created. Notifications can be sent, for example, using email.

Inviter 245 is responsible for sending out invitations to participants when a negotiation has been finalized. Invitations can be sent out using, for example, email with embedded data from external calendars.

A global optimizer 250 is an optional component that provides global optimizations of open negotiations on the server. The global optimizer 250 is triggered periodically or manually. The global optimizer 250 takes as input all the negotiations on the server and computes an optimal schedule for each negotiation given all the existing constraints. The problem is NP-complete, but there exists adequate approximation algorithms, e.g., the Ice Cube algorithm, as described for example in Anne-Marie Kermarrec et al., “The Ice Cube approach to the reconciliation of divergent replicas,” Twentieth ACM Symposium on Principles of Distributed Computing (PODC2001), 26-29 Aug. 2001, Newport, R.I. (USA). The optimized results support the meeting organizer in determining an optimal time for the negotiated event.

The client interacts with the authenticator 240 to gain the proper credentials to access the negotiation server 15. If authentication succeeds, the returned credentials are included with each request to the negotiation server 15.

The calendar retriever 230 accesses external calendaring and scheduling system, if available, to incorporate schedules and free-time information into negotiation objects. Such information is used to support the selection of an optimal timeslot for the event, and for automatically updating offered time when external schedules are updated.

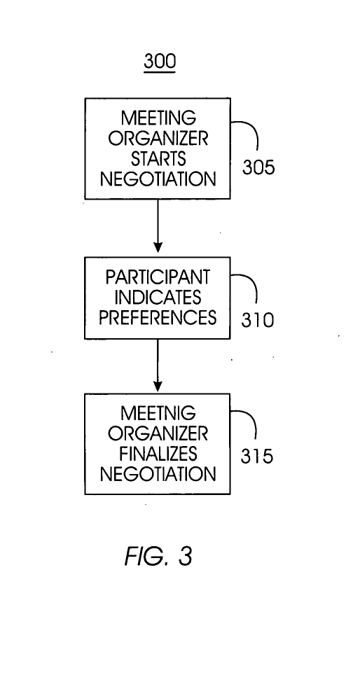

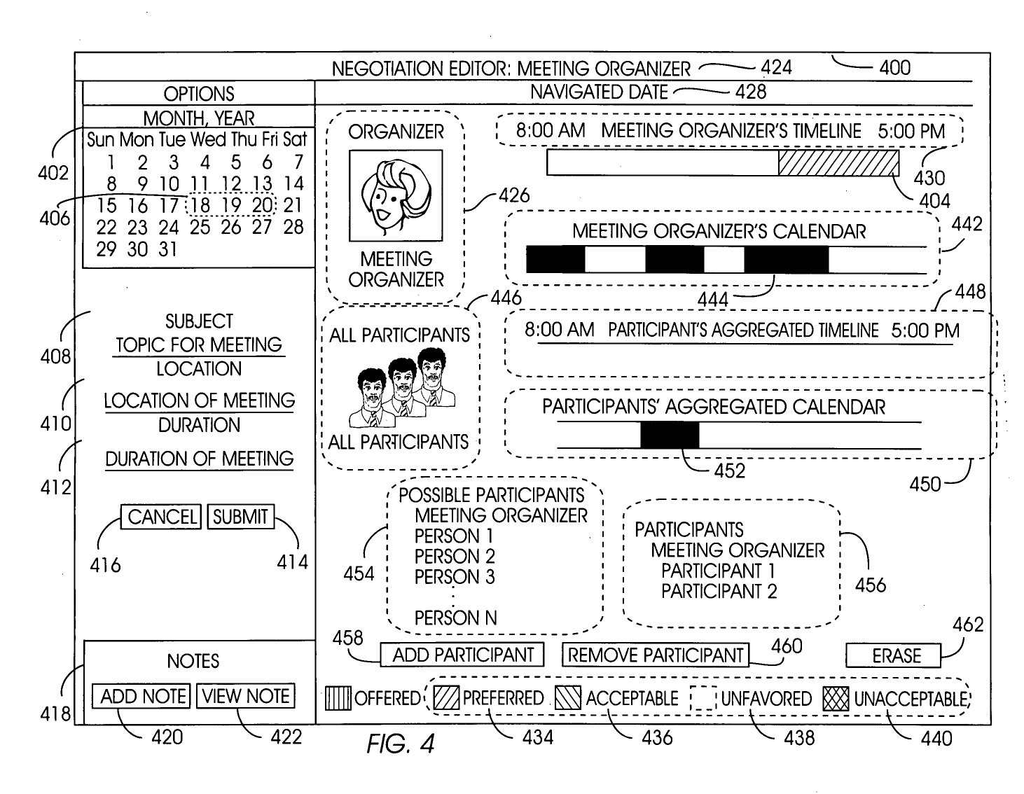

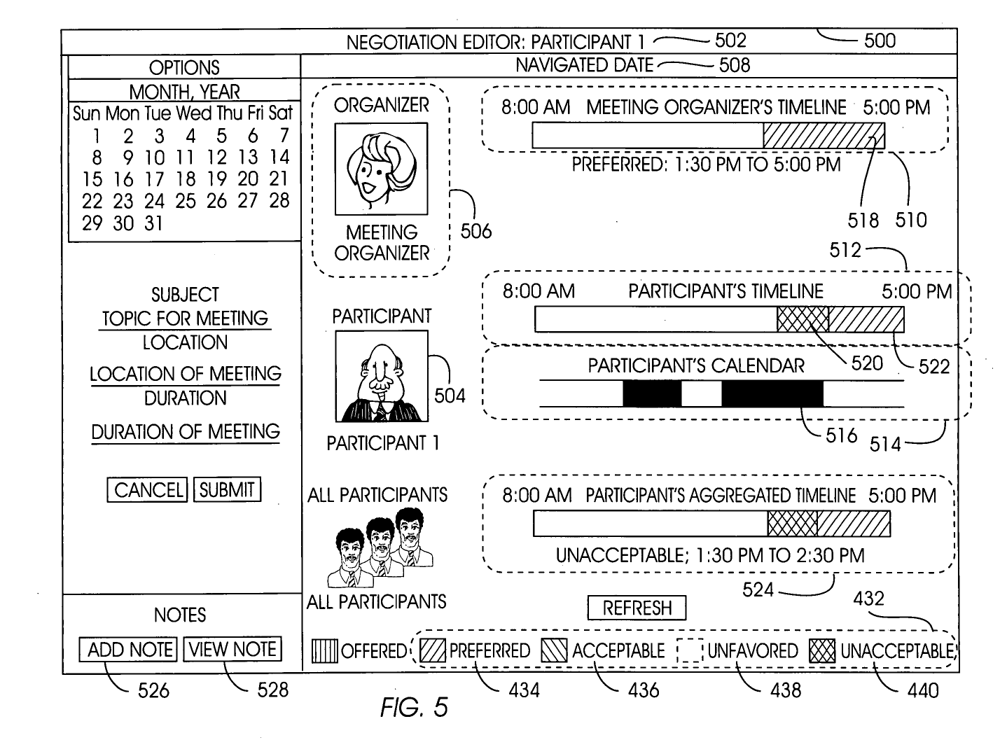

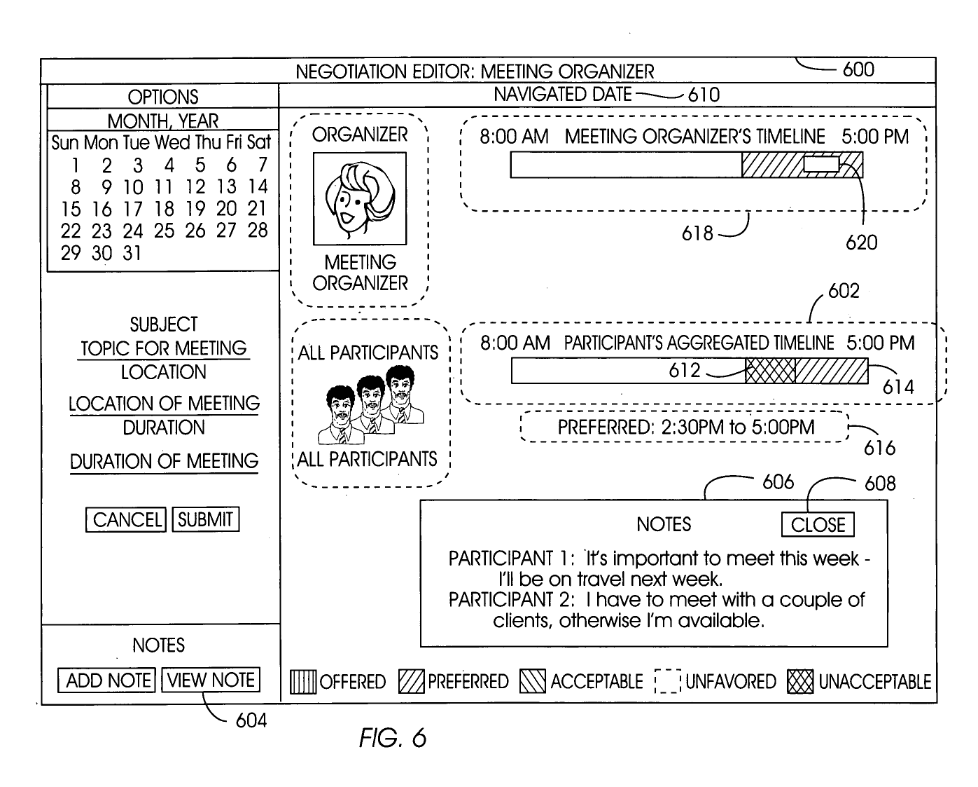

A method 300 for negotiating a meeting from the perspective of the meeting organizer and participants is illustrated by the high-level process flow chart of FIG. 3. At step 305, the meeting organizer starts a negotiation. An exemplary screen shot of FIG. 4 illustrates the options and features the meeting organizer may use when initiating a negotiation. A participant indicates meeting preferences at step 310. Options and features available of the participant are illustrated by the exemplary screen shot of FIG. 5. The meeting organizer finalizes negotiation at block 315, as illustrated by the exemplary screen shot of FIG. 6.

FIG. 4 illustrates in the form of a screen shot an exemplary user interface 400 for a meeting organizer starting a negotiation using system 10. A multiple date picker 402 allows the meeting organizer to select a day or days on which the desired meeting might occur. Since events with negotiable time may occur on a range of dates, extensions to a standard date picker component are made to support the selection of multiple days. The meeting organizer selects these days and uses the offered time 404 to set the time ranges for each day. Participants may view the various days one at a time by clicking on selected dates.

Days selected by the meeting organizer are highlighted, as indicated by a border around the selected dates 406. Different highlights may indicate different status for each date. For instance, a day marked in red may indicate one in which time was set aside by the organizer; however, all available time slots on that date have been removed by the participants.

Selected dates 406 allow the meeting organizer to use a feature of system 10, bounded negotiations. Bounded negotiations allow the meeting organizer to offer a meeting any time within a specified boundary in which the meeting time may be negotiated. In contrast, the conventional method of organizing meetings sets the meeting time in advance and then negotiates attendance.

Other options and features of system 10 as illustrated by user interface 400 are subject 408, location 410, and flexible duration 412. The meeting organizer enters the meeting topic at subject 408. Event location 410 is entered at location 410. Duration of the event as well as start time may be negotiable. The meeting organizer may specify a time interval for the meeting at duration 412.

When the meeting organizer has finished entering the options of the event and negotiation, he can “submit” the negotiation by selecting submit 414. System 10 then notifies participants of the pending negotiation. When cancel 416 is selected, the negotiation process is exited, and no changes are saved.

System 10 allows annotation of the meeting negotiation process through notes 418. Participants and the meeting organizer have the ability to comment on aspects of the event by selecting add note 420. Annotated comments might comprise, for example, the participants availability, special circumstances, items they might bring to the meeting, etc. Annotated comments may be viewed by selecting view note 422.

Logged in user 424 displays the current user name. A picture 426 of the logged in user 424 is displayed, if available. As shown in user interface 400, the current logged in user 424 is the meeting organizer.

Navigated date 428 displays the date to which the logged in user 424 is currently navigated. Possible dates for navigated date 428 are selected by the meeting organizer using selected dates 406. For navigated date 428, a timeline 430 of the meeting organizer displays a range of time and the time preferences of the organizer. In the exemplary user interface 400, timeline 430 is framed by a typical business day; however, the endpoints of timeline 430 are adjustable.

Within the timeline 430, the meeting organizer can designate time intervals and associate preferences 432 with those time intervals through offered time 404. Exemplary preferences comprise preferred 434, acceptable 436, unfavored 438, and unacceptable 440. Using preferences 432, the meeting organizer can specify a finer level of granularity than just free/busy.

Access to the meeting organizer's calendar is not required by system 10. However, if it is available, as shown by meeting organizer's calendar 442, system 10 can utilize information in an electronic calendar maintained by the meeting organizer to present an overview to the meeting organizer exposing potential conflicts. Times already scheduled are indicated, for example, by blocks such as block 444.

The meeting organizer may review schedule information for one participant or for all participants as an aggregate. The user interface 400 indicates whether the meeting organizer is viewing calendaring information for an individual or an aggregate in the participant display 446. In the exemplary user interface 400, the meeting organizer is reviewing participants in aggregate such that an icon labeled “All Participants” is shown in participant display 446.

Consequently, system 10 displays an aggregate of responses from participants in participants' aggregated timeline 448. User interface 400 illustrates an exemplary interface with the meeting organizer during the negotiation creation phase; consequently, no times are shown in the participants' aggregated timeline 448. An aggregate of the participant's calendar is shown in participants' aggregated calendar 450. Access to participant's calendars is not required; however, if available, system 10 can utilize information in an electronic calendar maintained by participants to present an overview to the meeting organizer exposing potential conflicts. Times already scheduled are indicated, for example, by blocks such as block 452.

Users from which the meeting organizer can select participants are displayed in possible participants 454. These users may be from the meeting organizer's address book, etc. Participants that have been selected by the meeting organizer for the event are listed in participants 456. The meeting organizer can add or remove participants from the event by selecting add participant 458 or remove participant 460. If the meeting organizer makes an error in creating the meeting negotiation, he may select erase 462. Erase 462 is used to fix a time interval. For example, if a participant indicates that the time interval 2:00 P.M.-5:00 P.M. is preferred, but then the participant realizes that he or she needs to leave at 4:30 P.M. the participant can erase the 4:30 P.M.-5:00 P.M. preferred indicator.

FIG. 5 illustrates in the form of a screen shot an exemplary user interface 500 for a participant responding to a negotiation using system 10. Logged in user 502 displays the current user name, participant 1. A picture 504 of the logged in user 502 is displayed, if available, as is a picture of the meeting organizer 506.

Navigated date 508 displays the date to which the logged in user is currently navigated. For the navigated date 508, a timeline 510 displays a range of time and the time preferences designated by the meeting organizer. Given the time offered by the meeting organizer, the participant can associate his own preferences using timeline 512. Within the timeline 512, the participant can designate time intervals and associate preferences 432. Exemplary preferences comprise preferred 434, acceptable 436, unfavored 438, and unacceptable 440. Using preferences 432, the participant can specify a finer level of granularity than just free/busy. If the participant's calendar is accessible to system 10, system 10 displays scheduled events in the participant's calendar 514 using blocks such as block 516.

Comparing participant's calendar 514 with offered meeting time 518, participant 1 notices that he has a conflict at 1:30 P.M. to 2:30 P.M. Consequently, he indicates in participant's timeline 512 that 1:30 P.M. to 2:30 P.M. is unacceptable as indicated by block 520. Participant 1 indicates that the remaining possible meeting times, 2:30 P.M. to 5:00 P.M. are preferred as indicated by block 522. An aggregate of all the offered times with preferences for all the participants is displayed in participants' aggregated calendar 524.

The participant may annotate his response to the meeting negotiation by selecting add note 526. Annotations provided by other participants may be viewed by selecting view note 528.

FIG. 6 illustrates in the form of a screen shot an exemplary user interface 600 for a meeting organizer finalizing a negotiation using system 10. Finalizing a negotiation initiates an invitation to all meeting participants. To select the meeting time, the meeting organizer reviews the participants' aggregated timeline 602 and annotations provided by participants. The meeting organizer views the annotations by selecting view note 604. System 10 then displays notes 606, showing any additional information participants may have provided about the meeting or their availability, for example. The meeting organizer may collapse the display of notes 606 by selecting close 608.

The participants' aggregated timeline 602 displays the timeline input from all the participants. In the example of user interface 600, participants have indicated that for the navigated date 610, time 1:30 P.M. to 2:30 P.M. is unacceptable, as indicated by block 612. Acceptable times for meeting participants are indicated by block 614. A summary of the acceptable meeting times is provided by summary 616.

The meeting organizer designates the actual time interval to schedule the meeting given the originally offered time interval(s) by the organizer shown in the meeting organizer's timeline 618, the participant's aggregated timeline 602, and the participant's comments shown in notes 606. The meeting organizer selects the actual time interval 620 for the meeting on the meeting organizer's timeline 618 to set the meeting time.

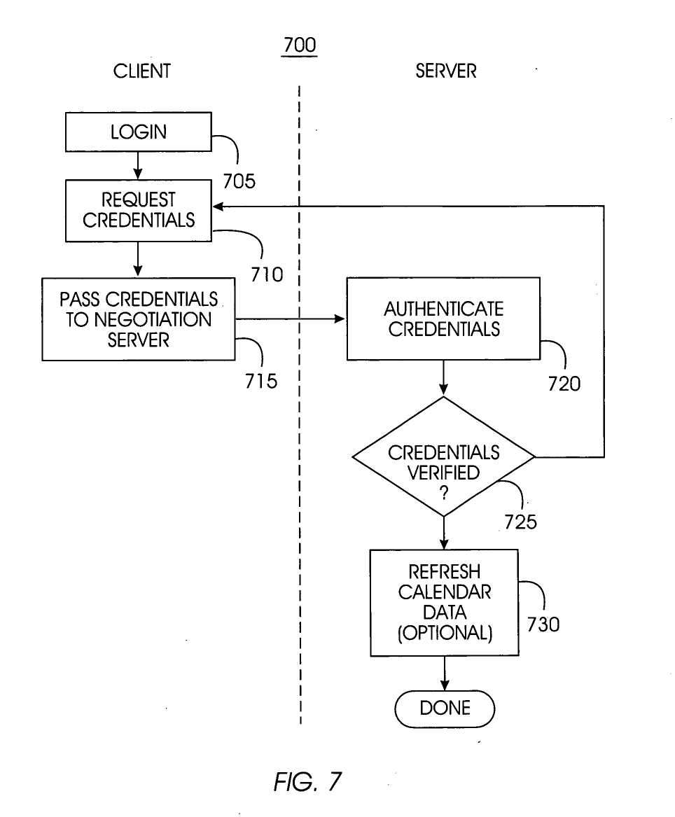

A method 700 of a flow of control by system 10 for login is illustrated by the process flow chart of FIG. 7. A user on the client side of system 10 logs into system 10 at step 705. System requests the user's credentials at step 710, and the user enters his credentials in the form of a user id and password at step 715. System 10 passes the user's credentials to the negotiation server 15 at step 715. System 10 verifies the authenticity of the credentials at step 720 using authenticator 240. If authentication fails at decision step 725, system 10 proceeds to step 710 and challenges the user again. Otherwise, system 10 may optionally refresh the existing calendar data for the user in the cache of system 10.

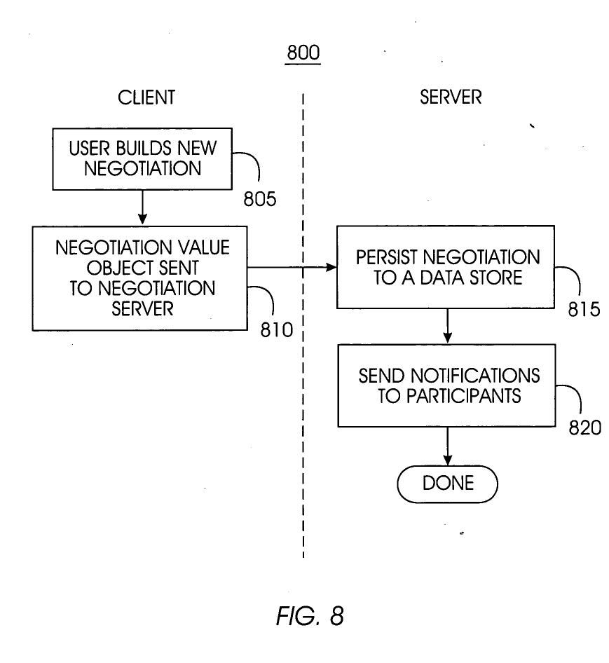

A method 800 of a flow of control by system 10 for creating a negotiation is illustrated by the process flow chart of FIG. 8. A user who is the meeting organizer initiates or builds a new negotiation at step 805. Building a negotiation comprises, for example, selecting the participants and their roles, identifying the subject of the event, and proposing offered dates and times. A data object such as one constructed in Java carries the information about the negotiation; this data object is the negotiation value object. The negotiation value object is sent to the negotiation server 15 at step 810. The negotiation object is persisted to a data store such as a database at step 815 by negotiation persister 225. Notifications comprising a unique negotiation identifier are sent to all participants selected by the meeting organizer at step 820, informing them of the pending negotiation.

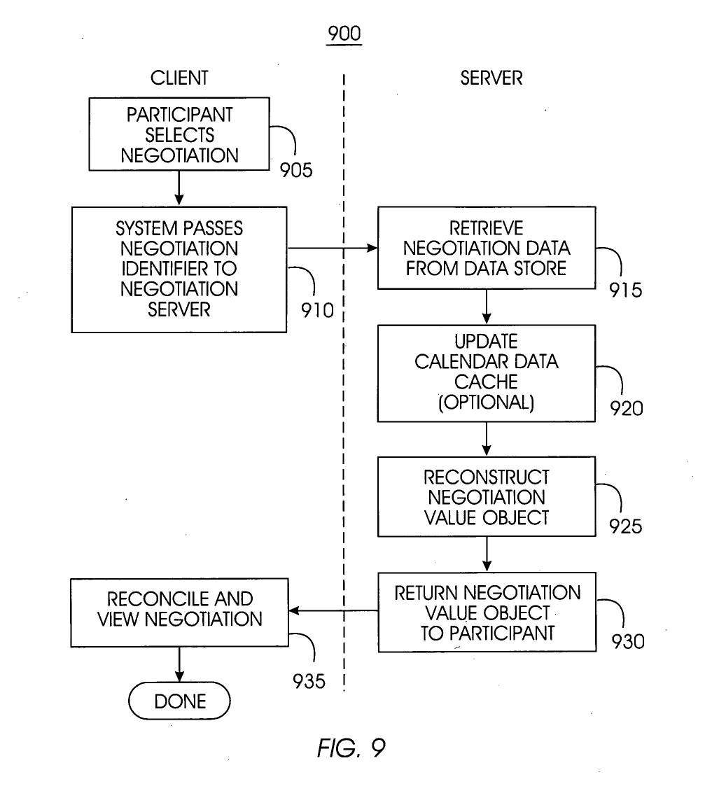

A method 900 of a flow of control by system 10 for retrieving a negotiation by a participant is illustrated by the process flow chart of FIG. 9. A participant logs into system 10 using the login procedure of method 700. The participant of a negotiation then selects at step 905 the negotiation identifier for the negotiation as provided in the notification. A participant may have several negotiations to process at any one time.

System 10 passes the selected negotiation identifier to the negotiation server 15 at step 910. System 10 retrieves the persisted negotiation information from the data store at step 915. At step 920, system 10 optionally updates the calendar data cache for the participant to present the latest snapshot of his available or committed time, if calendar data is available to system 10.

System 10 reconstructs the negotiation value object at step 925 from the data retrieved for the negotiation identifier and any available calendar data. The negotiation value object is returned to the participant at step 930. The participant views and reconciles the negotiation with his own calendar at step 935, providing preferences for meetings, annotations, etc.

Entity bean/database tables needed to support persistence in system 10 comprise an event table, a participant table, a user table, a timeslot table, a property table, and an annotation table. The event table comprises event information such as event description, location, duration, etc. The participant table comprises participant identities, the roles of participant identities such as required or optional, etc. The user table comprises user IDs, email addresses, time zones, etc. The timeslot table comprises start and end times, time zones, preference levels, etc. The annotation table comprises user IDs, users' comments, etc.

It is to be understood that the specific embodiments of the invention that have been described are merely illustrative of certain applications of the principle of the present invention. Numerous modifications may be made to negotiating schedules while preserving privacy through a shared representation invention described herein without departing from the spirit and scope of the present invention. Moreover, while the present invention is described for illustration purpose only in relation to the Internet, it should be clear that the invention is applicable as well to, for example, local area networks, wide area networks, or any application where computers may communicate with one another.

1. A calendaring method for negotiating schedules among a plurality of participants, comprising:
specifying availability preferences of the plurality of participants;
automatically proposing an event plan reflective of the availability preferences of the plurality of participants; and
automatically providing the plurality of participants with options to accept the event plan, comprising at least one of: an option to decline the event plan, and an option to iteratively propose an alternative event plan.

2. The method of claim 1, wherein specifying the availability preferences comprises identifying at least one preference indicator.

3. The method of claim 1, further comprising weighting the preferences.

4. The method of claim 1, further comprising linking the preferences to selectively accessible justifications.

5. The method of claim 1, further comprising graphically displaying the preferences.

6. The method of claim 1, wherein the plurality of participants comprise at least one of: a meeting organizer, a participant, an allowable replacement, and a delegated stand-in.

7. The method of claim 1, wherein the proposed alternative event plan comprises an intentionally imprecise specification of at least one parameter.

8. The method of claim 1, wherein the proposed alternative event plan comprises an intentionally imprecise specification of at least one constraint.

9. The method of claim 1, further comprising automatically selecting an option to accept the event plan according to a history of past event plans

10. The method of claim 1, wherein automatically proposing the event plan comprises allowing for bounded negotiations between the plurality of participants, to offer a meeting within a specified boundary in which the meeting time may be negotiated.

11. A calendaring computer program product having instruction codes for negotiating schedules among a plurality of participants, comprising:
a first set of instruction codes for specifying availability preferences of the plurality of participants;
a second set of instruction codes for automatically proposing an event plan reflective of the availability preferences of the plurality of participants; and
a third set of instruction codes for automatically providing the plurality of participants with options to accept the event plan, comprising at least one of: an option to decline the event plan, and an option to iteratively propose an alternative event plan.

12. The computer program product of claim 11, wherein the preferences comprise at least one preference indicator from: an offered preference, a preferred preference, an acceptable preference, a problematic preference, a disfavored preference, and an unacceptable preference.

13. The computer program product of claim 11, wherein the preferences are weighted.

14. The computer program product of claim 11, wherein the preferences are linked to selectively accessible justifications.

15. The computer program product of claim 11, wherein the preferences are graphically displayed.

16. The computer program product of claim 11, wherein the plurality of participants comprise at least one of: a meeting organizer, a participant, an allowable replacement, and a delegated stand-in.

17. The computer program product of claim 11, wherein the proposed alternative event plan comprises an intentionally imprecise specification of at least one parameter.

18. The computer program product of claim 11, wherein the proposed alternative event plan comprises an intentionally imprecise specification of at least one constraint.

19. The computer program product of claim 11, further comprising a fourth set of instruction code for automatically selecting an option to accept the event plan according to a history of past event plans.

20. The computer program product of claim 19, wherein the fourth set of instruction code allows for bounded negotiations between the plurality of participants, to offer a meeting within a specified boundary in which the meeting time may be negotiated.

21. A calendaring service for negotiating schedules among a plurality of participants, comprising:
a specification of availability preferences of the plurality of participants;
an automatic proposal of an event plan reflective of the availability preferences of the plurality of participants; and
an automatic provision of the plurality of participants with options to accept the event plan, comprising at least one of: an option to decline the event plan, and an option to iteratively propose an alternative event plan.

22. The service of claim 21, wherein the preferences comprise at least one preference indicator from: an offered preference, a preferred preference, an acceptable preference, a problematic preference, a disfavored preference, and an unacceptable preference.

23. The service of claim 21, wherein the preferences are weighted;

24. The service of claim 21, wherein the preferences are linked to selectively accessible justifications.

25. The service of claim 21, wherein the preferences are graphically displayed.

26. The service of claim 21, wherein the plurality of participants comprise at least one of: a meeting organizer, a participant, an allowable replacement, and a delegated stand-in.

27. The service of claim 21, wherein the proposed alternative event plan comprises an intentionally imprecise specification of at least one parameter.

28. The service of claim 21, wherein the proposed alternative event plan comprises an intentionally imprecise specification of at least one constraint.

29. The service of claim 21, further comprising an automatic selection of an option to accept the event plan according to a history of past event plans.

30. The service of claim 29, wherein the automatic selection of the option to accept the event plan allows for bounded negotiations between the plurality of participants, to offer a meeting within a specified boundary in which the meeting time may be negotiated.
